(19) United States
(12) Patent Application Publication
(10) Pub. No.: US 2009/0153569 A1
(43) Pub. Date: Jun. 18, 2009

(54) Method for tracking head motion for 3D facial model animation from video stream

(75) Inventors: Jeung Chul Park, Daejeon (KR); Seong Jae Lim, Daejeon (KR); Chang Woo Chu, Daejeon (KR); Ho Won Kim, Daejeon (KR); Ji Young Park, Daejeon (KR); Bon Ki Koo, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/314,859

(22) Filed: Dec. 17, 2008

(30) Foreign Application Priority Data
Dec. 17, 2007 (KR) 10-2007-0132851

(51) Int. Cl. G06T 15/70; G06K 9/00

(52) U.S. Cl. 345/474; 382/107

(57) ABSTRACT

A head motion tracking method for three-dimensional facial model animation, the head motion tracking method includes acquiring initial facial motion to be fit to an image of a three-dimensional model from an image inputted by a video camera; creating a silhouette of the three-dimensional model and projecting the silhouette; matching the silhouette created from the three-dimensional model with a silhouette acquired by a statistical feature point tracking scheme; and obtaining a motion parameter for the image of the three-dimensional model through motion correction using a texture to perform three-dimensional head motion tracking. In accordance with the present invention, natural three-dimensional facial model animation based on a real image acquired with a video camera can be performed automatically, thereby reducing time and cost.

### CROSS-REFERENCE(S) TO RELATED APPLICATIONS

The present invention claims priority of Korean Patent Application No. 10-2007-0132851, filed on Dec. 17, 2007 which is incorporated herein by reference.

### FIELD OF THE INVENTION

The present invention relates to a method for tracking facial head motion; and, more particularly, to a method, for tracking head motion for three-dimensional facial model animation, that is capable of performing natural facial head motion animation in accordance with an image acquired with a video camera by forming a facial model animation system which deforms a facial model and applying a motion parameter acquired with a head motion tracking system to the facial model animation system, in order to track the head motion of the three-dimensional model from the image.

### BACKGROUND OF THE INVENTION

Conventional methods for tracking head motion include a method using feature points and a method using textures.

Methods for obtaining a three-dimensional head model using feature points include methods for obtaining head motion by creating a two-dimensional model having, as features, five points including three points of a facial image, i.e., two left and right end points of eyes and one point of a nose and two end points of a mouth, creating a three-dimensional model based on the two-dimensional model, and calculating translation and rotation values of the three-dimensional model using a two-dimensional change between two images. In these methods, when the modified three-dimensional model is projected to an image, the projected image appears similarly with that of unmodified three-dimensional model even though the original models of the two are different. This is because when models are projected to an image on a three-dimensional space, they disadvantageously appear to be similar on the image, although they are different on the three-dimensional space. Therefore, these methods have a difficulty in obtaining the precise motion.

The method for obtaining a three-dimensional head model using textures includes a method for acquiring a facial texture of an image, creating a template of the texture, and tracking head motion through template matching. The method using template-based textures is advantageously capable of tracking the motion precisely, as compared with the above method using features of three or five points. The method helps us find the more precise motion due to use of excessive memory, but is also time-consuming and susceptible to sudden motions.

### SUMMARY OF THE INVENTION

It is, therefore, an object of the present invention to provide a method capable of performing natural facial head motion animation in accordance with an image acquired by one video camera by forming a facial model animation system which deforms a facial model and applying a motion parameter acquired by a head motion tracking system to the facial model animation system.

In accordance with the present invention, there is provided a head motion tracking method for three-dimensional facial model animation, the head motion tracking method including: acquiring initial facial motion to be fit to an image of a three-dimensional model from an image inputted by a video camera; creating a silhouette of the three-dimensional model and projecting the silhouette; matching the silhouette created from the three-dimensional model with a silhouette acquired by a statistical feature point tracking scheme; and obtaining a motion parameter for the image of the three-dimensional model through motion correction using a texture to perform three-dimensional head motion tracking.

It is preferable that in the acquiring, feature points from the three-dimensional model and feature points from a two-dimensional image are selected and then matched to thereby calculate an initial motion parameter.

It is preferable that in the creating and projecting, a visualization area of each face of a three-dimensional mesh is calculated to obtain the silhouette of the three-dimensional model at a present viewing angle, and then, the silhouette is projected to the image of the three dimensional model by using an internal or an external parameter, after performing camera correction.

It is preferable that in the matching, the silhouette of the three-dimensional model obtained using an initial parameter or a corrected parameter is matched with a two-dimensional silhouette obtained by a statistical tracking scheme to thereby obtain a motion parameter resulting in a smallest difference between the silhouettes.

It is preferable that in the obtaining, a template is created using a present texture, and then, precise motion parameter correction is performed through template matching for a next image.

In accordance with the present invention, natural three-dimensional facial model animation based on a real image acquired with a video camera can be performed automatically, thereby reducing time and cost.

### BRIEF DESCRIPTION OF THE DRAWINGS

The above and other objects and features of the present invention will become apparent from the following description of the embodiments given in conjunction with the accompanying drawings, in which:

FIG. 1 illustrates a configuration block diagram of a computer and a camera capable of tracking head motion for three-dimensional facial model animation according to an embodiment of the present invention;

FIG. 2 is a flowchart illustrating a facial model animation process according to an embodiment of the present invention;

FIG. 3 is a flowchart illustrating a head motion tracking process according to an embodiment of the present invention;

FIG. 4 illustrates a result of fitting a model having a skeleton structure to an image according to an embodiment of the present invention;

FIG. 5 illustrates a three-dimensional model silhouette according to an embodiment of the present invention;

FIG. 6 illustrates projection of a three-dimensional model silhouette and a silhouette acquired by tracking feature statistically according to an embodiment of the present invention; and

FIG. 7 illustrates a head model tracking result according to an embodiment of the present invention.

### DETAILED DESCRIPTION OF THE PREFERRED EMBODIMENTS

Hereinafter, the embodiments of the present invention will be described in detail with reference to the accompanying drawings so that they can be readily implemented by those skilled in the art.

A technical gist of the present invention is providing the technique that makes it possible to acquire a motion parameter rapidly and precisely by acquiring an initial motion parameter with feature points acquired from an image generated by a video camera and feature points of a three-dimensional model; and acquiring a precise motion parameter through texture correction in order to track facial head motion from the image. This can easily achieve the aforementioned object of the present invention.

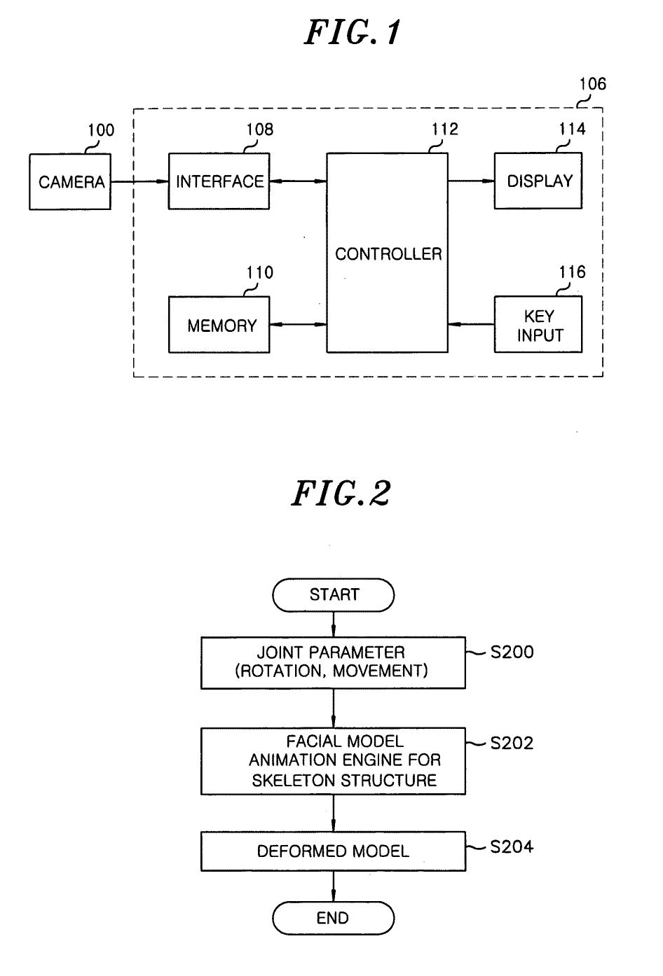

FIG. 1 illustrates a configuration of a camera and a computer having an application program for tracking facial head motion using an image generated from the video camera in accordance with an embodiment of the present invention.

A camera 100 takes a face and transmits a facial image to a computer 106. An interface 108 is connected with the camera 100 to transmit facial image data of a person taken by the camera to a controller 112. A key input unit 116 includes a plurality of numeric keys and function keys to transmit key data generated from key input by a user to the controller 112.

A memory 110 stores an operation control program, to be executed by the controller 112, for controlling general operation of the computer 106 and an application program for tracking head motion of a facial model from the image generated by the camera in accordance with the present invention. A display unit 114 displays a three-dimensional face which is processed with the facial model animation and head motion tracking under control of the controller 112.

The controller 112 controls the general operation of the computer 106 using the operation control program stored in the memory 110. The controller 112 also performs facial model animation and head motion tracking on the facial image generated by the camera to create a three-dimensional facial model.

FIG. 2 is a flowchart illustrating a three-dimensional facial model animation process using a skeleton structure, which consists of joints having rotation and translation values of motion parameters, in accordance with an embodiment of the present invention.

Rotation and translation values are applied to joints for head motion of an entire face to deform a three-dimensional facial model (S200). By applying new values to the parameters for the head motion joints, the skeleton structure is deformed because it is hierarchical. In the hierarchical structure, deformation of an upper joint affects a lower joint thereby leading to a new value of the lower joint. The deformed joints affect and deform a predetermined portion of the face. This process is performed automatically by a facial model animation engine (S202). Thus, a naturally deformed facial model as a final processed result can be obtained by applying the facial model animation engine (S204).

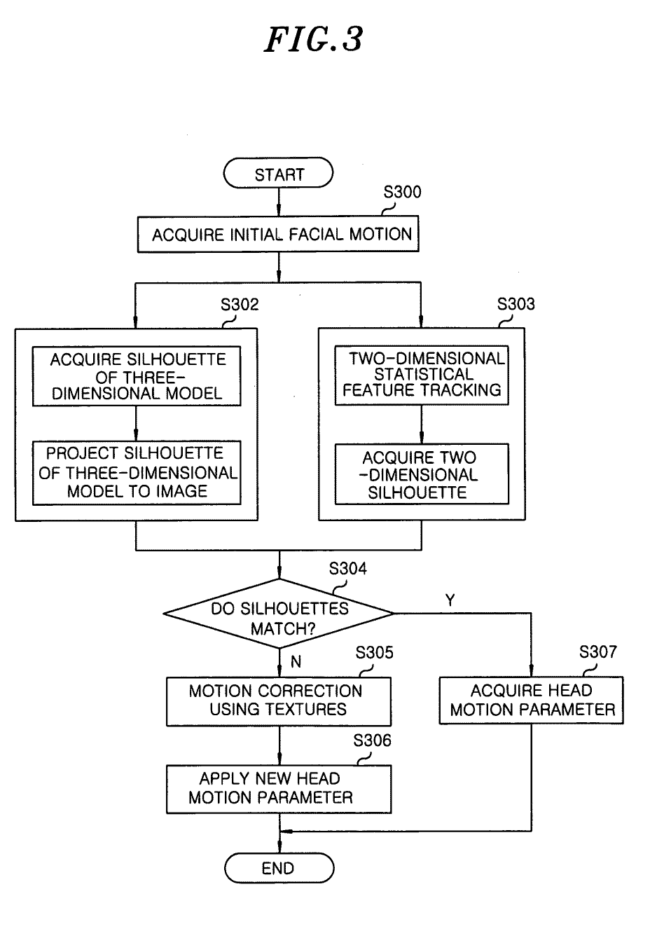

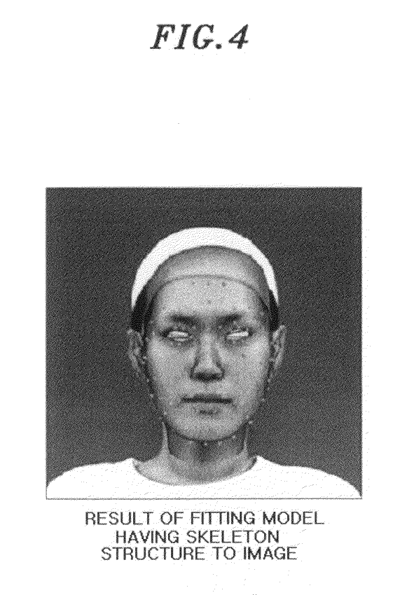

FIG. 3 is a flowchart illustrating a process of performing head motion tracking on a facial image generated by a video camera in accordance with an embodiment of the present invention. Through the head motion tracking, information on joint rotation and translation related to the head motion is obtained.

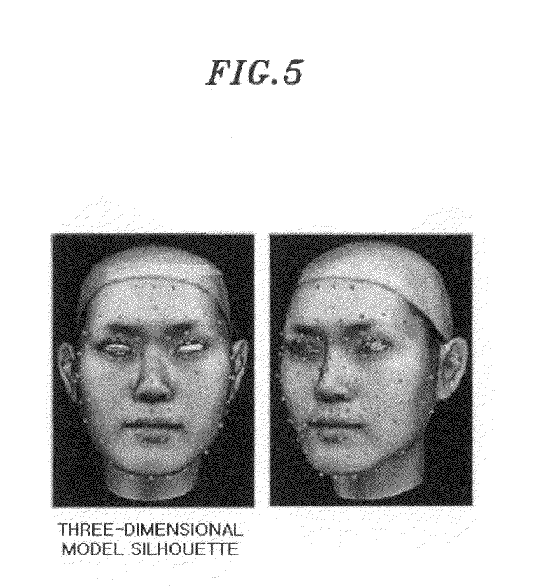

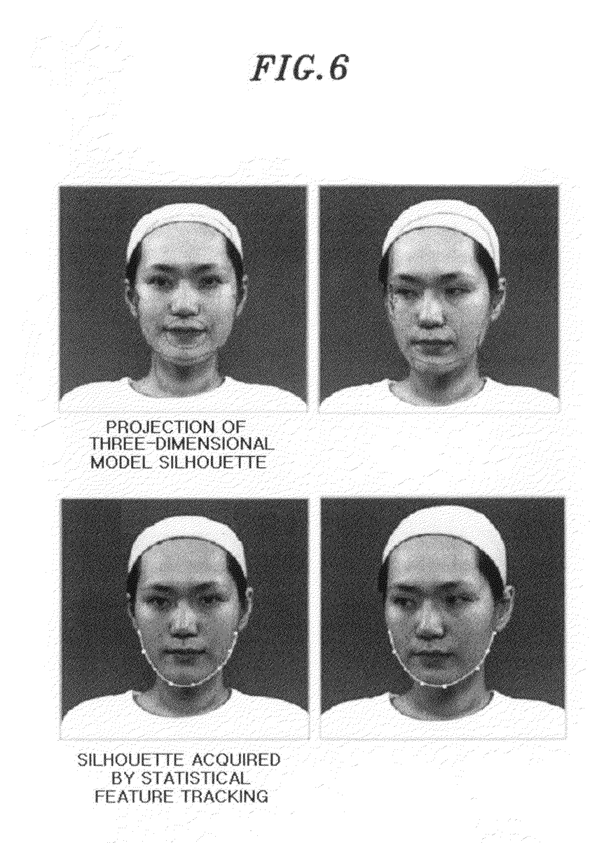

First, a joint parameter of an initial version of a three-dimensional model laid on an image may be obtained using feature points of the three-dimensional model and the image (S300). Then, a three-dimensional silhouette obtained with a silhouette of the three-dimensional model as shown in FIG. 5 and projecting it to the image (S302); and a two-dimensional silhouette consisting of feature points obtained by tracking an expression change of a video sequence to which a model of statistical feature points is inputted (S303) may be acquired thereby making it possible with these two silhouettes to track a motion parameter as shown in FIG. 6.

A determination is then made as to whether the three-dimensional silhouette matches the two-dimensional silhouette (S304). If the silhouettes match, the desired head motion parameter has been obtained (S307) and if the silhouettes do not match, a new motion parameter is required.

Textures in an image are used for motion correction (S305). The texture motion correction will now be described in brief.

First, for the texture motion correction, a new model called a cylinder model is created to acquire a texture map of a facial area in the image. This model may be a cylinder texture map that is normally used in a texture map of a computer graphics (CG) model. By applying the texture of the facial area in the image to the created cylinder, a texture map of a first image is created. The texture map is used to create a template by performing small motion (rotation and translation). The template and a texture map of a next image are used to determine a motion parameter of the next image.

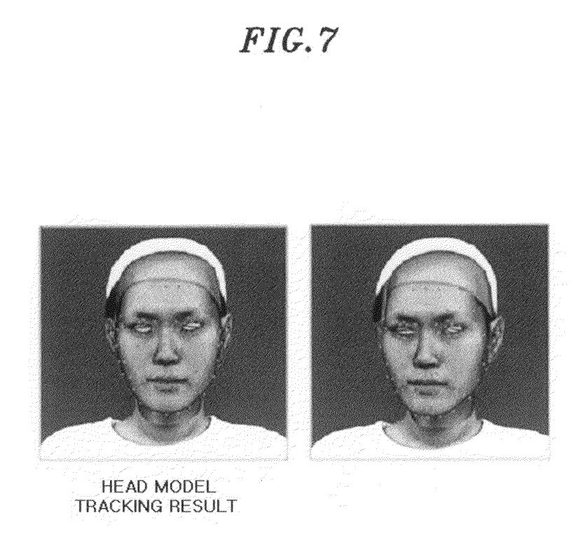

Since the obtained motion parameter may not represent final motion, it is necessary to check whether the obtained motion parameter represents the final motion. First, the obtained motion parameter is applied to the model animation system to deform the model (S306), and then, the silhouette of the three-dimensional model is obtained and projected to the image again. This process is repeatedly performed until the silhouettes match. The motion parameter for each frame is obtained for rendering, resulting in natural head motion animation as shown in FIG. 7.

While the invention has been shown and described with respect to the embodiments, it will be understood by those skilled in the art that various changes and modifications may be made without departing from the scope of the invention as defined in the following claims.

What is claimed is:

1. A head motion tracking method for three-dimensional facial model animation, the head motion tracking method comprising:
acquiring initial facial motion to be fit to an image of a three-dimensional model from an image inputted by a video camera;
creating a silhouette of the three-dimensional model and projecting the silhouette;
matching the silhouette created from the three-dimensional model with a silhouette acquired by a statistical feature point tracking scheme; and
obtaining a motion parameter for the image of the three-dimensional model through motion correction using a texture to perform three-dimensional head motion tracking.

2. The head motion tracking method of claim 1, wherein in the acquiring, feature points from the three-dimensional model and feature points from a two-dimensional image are selected and then matched to thereby calculate an initial motion parameter.

3. The head motion tracking method of claim 1, wherein in the creating and projecting, a visualization area of each face of a three-dimensional mesh is calculated to obtain the silhouette of the three-dimensional model at a present viewing angle, and then, the silhouette is projected to the image of the three dimensional model by using an internal or an external parameter, after performing camera correction.

4. The head motion tracking method of claim 1, wherein, in the matching, the silhouette of the three-dimensional model obtained using an initial parameter or a corrected parameter is matched with a two-dimensional silhouette obtained by a statistical tracking scheme to thereby obtain a motion parameter resulting in a smallest difference between the silhouettes.

5. The head motion tracking method of claim 1, wherein in the obtaining, a template is created using a present texture, and then, precise motion parameter correction is performed through template matching for a next image.
